(19) United States
(12) Patent Application Publication
(10) Pub. No.: US 2002/0182326 A1
(43) Pub. Date: Dec. 5, 2002

(54) Coating agent, parts coated with the same and method for preventing fixing of weld spatters

(75) Inventors: Hideki Kakamu, Niwa-gun (JP); Shuji Ito, Niwa-gun (JP); Takahiro Seko, Niwa-gun (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: AOYAMA SEISAKUSHO CO., LTD., Nagoya-shi (JP)

(21) Appl. No.: 10/104,880

(22) Filed: Mar. 22, 2002

(30) Foreign Application Priority Data
Mar. 27, 2001 (JP) 90543/2001

(51) Int. Cl. B05D 3/02; B05D 1/02; B05D 1/18; C09K 3/00

(52) U.S. Cl. 427/376.1; 427/421; 427/430.1; 106/2

(57) ABSTRACT

There are disclosed a coating agent for preventing a fixing of a weld spatter, which comprises a coating material and a solvent for dispersing therein the coating material, wherein the coating material is graphite, a part coated with the above coating agent on at least a portion of the part to which a weld spatter spatters, to prevent the weld spatter from being fixed thereonto and a method for preventing fixing of weld spatters comprising coating the above coating agent onto at least a portion of a part to which a weld spatter spatters of a screw for welding, and drying the same.

### BACKGROUND OF THE INVENTION

1. Field of the Invention

The present invention relates to a coating agent for coating a portion to which a weld spatter spatters to prevent fixing of the weld spatters, a part coated with the coating agent and a method for preventing fixing of the weld spatters.

2. Prior Art

In the production lines for automobiles, etc., for fastening parts together, a weld screw such as a weld bolt or a weld nut made of steel, is automatically attached in advance to a member to be fastened, by means of an electric resistance weld, etc. in many cases. During the welding process, a weld spatters are generated and spatter, and, as shown in FIGS. 1 and 2, weld spatter 1 are fixed onto a weld screw on a thread face such as an external thread or an internal thread, thus causing a problem that the screw is difficult to be fastened. Further, when the weld spatters are fixed onto a part such as a pin, a spring, a casting, a pipe, a collar, a bracket, or a plate, which is made of a metal, a semiconductor, or a ceramic, another part cannot be fixed to the part or the appearance of the part is spoiled. For preventing weld spatter 1 from being fixed, for example, a screw whose thread face is coated with a coating agent comprising a fluorine resin such as Teflon (registered trademark) has been developed. In such a screw coated with a coating agent, even when weld spatter 1 spatters and attaches to the screw, the weld spatter 1 neither stick to nor be fixed onto the screw as such but can be easily removed when fastening the screw.

However, the fluorine resin is expensive and electrically non-conductive, and therefore, when a screw is entirely coated with a coating agent comprising the fluorine resin by dipping, the electrical conductivity of the resulting screw is not secured, so that the screw cannot be welded by, for example, an electric resistance weld. Therefore, there has been a need to fuse the coating agent only to the thread face, and thus, the coating of a coating agent comprising Teflon, etc. requires a very cumbersome operation, elevating the cost for production of the weld screws which prevent fixing of the weld spatter 1.

### SUMMARY OF THE INVENTION

The present invention has been made with a view toward solving the above-mentioned problems accompanying the conventional techniques and providing a coating agent having electrical conductivity, which is inexpensive and capable of coating the whole part of a weld screw, etc. by dip-coating, etc. and a part coated with the coating agent.

The coating agent for preventing fixing of a weld spatter of the present invention, which has been made for solving the above-mentioned problems, comprises a coating material and an organic solvent for dispersing therein the coating material, wherein the coating material is graphite.

Also, the present invention relates to a part coated with the above-mentioned coating agent on at least a portion of the part to which a weld spatter spatters, to prevent the weld spatter from being fixed thereonto.

The present invention further relates to a method for preventing fixing of weld spatters, which comprises coating the above-mentioned coating agent onto at least a portion of a part of a screw for welding to which a weld spatter spatters or fixes, and drying the same.

### BRIEF DESCRIPTION OF THE DRAWINGS

FIG. 1 is a perspective view of a weld nut to which a spatter adheres where the reference numeral 1 denotes a spatter.

FIG. 2 is a perspective view of a weld bolt to which a spatter adheres.

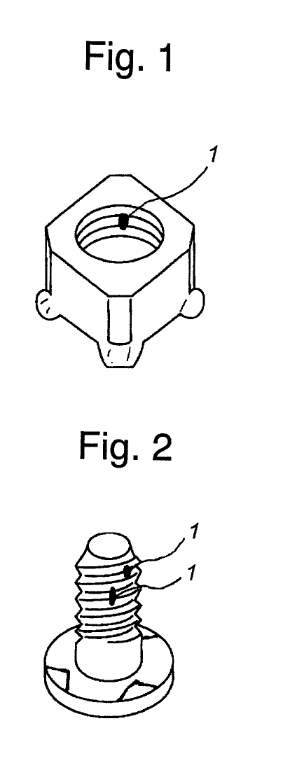

### DESCRIPTION OF THE PREFERRED EMBODIMENTS

In the following, the present invention will be described in detail.

The part of the present invention is characterized in that it is coated with the above-mentioned coating agent, at least at a portion of the part to which a weld spatter spatters, to prevent fixing of the weld spatter. As the part, a weld screw such as a weld nut or a weld bolt, or a part such as a pin, a spring, a casting, a pipe, a collar, a bracket or a plate, can be used.

In the coating agent for preventing fixing of a weld spatter of the present invention, by using graphite having electrical conductivity as the coating material, not only the thread face but also the whole of a part can be coated with the coating agent, and, even when a weld spatter adheres to a part, the weld spatter is not strongly fixed onto the part and can be easily removed therefrom.

The coating agent for preventing fixation of a weld spatter of the present invention comprises a coating material and a solvent for dispersing therein the coating material, and, as the coating material, inexpensive graphite is mainly used. Graphite has a crystal structure of hexagonal system comprising laminated hexagonal ring planes of carbons that are bonded through covalent bonds. The planes are bonded through a weak bond between a metal bond and a van der Waals force. Therefore, graphite is soft and has excellent lubricating performance, and thus stabilizes the coefficient of friction and advantageously improves the axial force when fastening a bolt. Further, graphite has electrical conductivity when a voltage is applied to graphite, since electrons move along the planes in the graphite to flow a current. However, graphite likely or easily disappear due to oxidation at 600° C. or higher. Therefore, when a part such as a weld screw, is subjected to high temperature conditions for a short time such that only a slight amount of graphite disappears due to oxidation, a coating material can be comprised only of graphite.

As the graphite to be used in the present invention, it is not particularly limited so long as it is commercially available as graphite, and any graphite may be used. As such a graphite, there may be mentioned, for example, a conventionally known carbon black such as actylene black, channel black, furnace black, lamp black, thermal black and the like, and commercially available product can be used.

However, when the part is subjected to high temperature conditions for a long time such that a large amount of graphite disappears due to oxidation, stability at high temperatures of the coating material according to the present invention can be improved by additionally adding boron nitride (BN) to graphite to prepare a coating material. Boron nitride is also called white graphite, and has the same crystal structure of hexagonal system as that of graphite and has excellent lubricating performance, but it has no free electron and thus is an insulator differing from graphite. Therefore, when boron nitride is used in the form of a mixture with graphite, the amount of boron nitride added is limited depending on the desired electrical conductivity, and it is desired that boron nitride is mixed with graphite in an amount of not more than 50% by weight based on the total amount of the graphite and boron nitride. When graphite is used as the coating material solely or in the form of a mixture with boron nitride in an amount that does not sacrifice the electrical conductivity and the surface of a part is coated with the resulting coating agent, the conductivity between an electrode and the part is not inhibited. Therefore, differing from the case where conventional Teflon is applied, when the coating agent of the present invention is used, the whole of a part can be coated, and coating for a part can be conducted by a simple operation. Incidentally, coating with the coating agent of the present invention may be carried out on the whole surface of the thread or only the surface of the thread portion.

With respect to each particle diameter of the above-mentioned graphite and boron nitride, a smaller particle diameter gives a more stable suspension or a larger adhesion strength. Therefore, it is desired that each of graphite and boron nitride is used in the form of powder having a particle diameter of 50 μm or less, preferably 5 to 10 μm or less.

As a solvent for dispersing therein the coating material, an alcohol such as methanol, ethanol, propanol, isopropanol, butanol, isobutanol, tert-butanol, pentanol, etc., a ketone such as acetone, methyl ethyl ketone, methyl isopropyl ketone, etc., or a non-aqueous organic solvent such as an aromatic hydrocarbon having a benzene nucleus as a basic skeleton, e.g., benzene, toluene, naphthalene, anthracene, etc. can be used. Graphite is dispersed in the above organic solvent or an appropriate mixture of the above organic solvents to prepare a graphite liquid. For adjusting the viscosity of the graphite liquid, an appropriate amount of water can be added to the graphite liquid, but the viscosity can be appropriately adjusted using only an alcohol, a ketone, an aromatic hydrocarbon, or a mixture thereof without adding water. When the above-mentioned alcohol, ketone or aromatic hydrocarbon is used as a solvent, the resulting graphite liquid can be of a quick-drying type. Therefore, the graphite liquid begins to be dried simultaneously with or can be dried in a short time immediately after the graphite liquid is applied to a part by coating, etc., enabling to form a graphite film in a short time on a part such as a weld screw, especially at a thread face, thus making it possible to coat the part with a coating agent for preventing a weld spatter from being fixed at high productivity.

In the present invention, an amount of graphite to be dispersed in the above-mentioned organic solvent is preferably 1 to 50% by weight, more preferably 3 to 35% by weight, particularly preferably 5 to 20% by weight based on the total amount of the graphite and organic solvent. If it exceeds 50% by weight, a viscosity of the coating agent becomes too high and coating is sometimes impossible, while if it is less than 1% by weight, coating effects are sometimes insufficient.

Further, to the coating agent of the present invention, a cellulose type thickening agent is preferably added. By adding such a thickening agent, a graphite film having good surface smoothness can be obtained. As the cellulose type thickening agent, there may be mentioned, for example, ethyl cellulose, carboxymethyl cellulose, nitrocellulose, cellulose acetate resin and the like.

Further, as a binder for stabilizing the coating material dispersed therein, a polyimide resin or a polybenzimidazole resin having a heat resistance can be used. In addition, a relatively inexpensive halogenated epoxy-modified phenolic resin can be added in the form of an aqueous solution or an aqueous dispersion to obtain a graphite liquid having a satisfactory adhesion strength. The thus obtained water-soluble or aqueous dispersion adhesive and the coating agent together form a suspension.

In the present invention, an amount of the above-mentioned binder to be added is preferably 0 to 50 parts by weight, more preferably 0 to 25 parts by weight as a solid content based on 100 parts by weight of the above-mentioned coating substance. If the amount of the binder exceeds 50 parts by weight, inconveniences sometimes occur such as lowering in conductivity, etc.

As a preferably composition of the coating agent according to the present invention, there may be mentioned, for example, a coating agent comprising 5 to 20% by weight of graphite, 0 to 1% by weight of a cellulose type thickening agent, 1 to 5% by weight of a hydrophilic organic solvent such as isopropanol, and the reminder being water (including pure water).

The part in which fixing of weld spatters is prevented according to the present invention is a part to which the above coating agent is coated on at least a portion of the part to which a weld spatter spatters or fixes. As such a part, there may be mentioned, for example, a screw for welding such as a weld nut or a weld bolt.

Also, the method for preventing fixing of weld spatters of the present invention comprises coating the above-mentioned coating agent onto at least a portion of a part of a screw for welding to which a weld spatter spatters or fixes, and drying the same. In the present invention, by coating the above coating agent onto at least a portion of a part of a screw to which a weld spatter spatters or fixes, even when the weld spatter spatters or fixes thereto, the weld spatter can be easily peeled off with the above coating agent.

The whole of a part can be coated with the coating agent comprising the above-mentioned coating material and organic solvent, and if necessary, a binder, by a spraying method or a dipping method. When it is intended to coat only a thread portion such as an external thread or an internal thread, with the coating agent, only a desired portion of a screw can be coated with the coating agent by coating.

### EXAMPLES

In the following, the present invention is explained by referring to Examples but the present invention is not limited by these Examples.

### Example 1

| | | |
|---|---|---|
| Coating material | Graphite powder | 100 g |
| | (particle diameter: 3 μm) | |
| Solvent | Butanol | 30 cc |
| | Methanol | 1,000 cc |
| | Xylene | 10 cc |

The above coating material and solvents are mixed with each other for 24 hours or longer, and filtered by a mesh filter, and water for adjusting the viscosity is added thereto to prepare a graphite liquid. The prepared graphite liquid is sprayed to a weld nut so that the graphite liquid is applied mainly to the thread face of the weld nut, and then, it is dried to form a graphite film on the weld nut. The weld nut having formed thereon a graphite film is fixed by electric resistance welding to a part to be fastened, but the spatter which spattered and adhered to the part is easily removed when fastening a bolt and no problem occurred when fastening the bolt, so that the lubricating effect of graphite enabled the coefficient of friction to be stable and the bolt could be fastened to the part to be fastened at a high axial force when fastening at a predetermined torque.

### Example 2

| | | |
|---|---|---|
| Coating material | Graphite powder | 120 g |
| | (particle diameter: 2 μm) | |
| | Boron nitride | 40 g |
| | (particle diameter: 1 μm) | |
| Binder | Epoxy-modified phenolic resin | 300 cc |
| Solvent | Water | 300 cc |

The above coating materials, solvent, and water are completely mixed with each other by means of a ball mill to prepare a suspension in which boron nitride is mixed with graphite. A weld nut is dipped in the prepared suspension so that the suspension is applied to not only the thread face but also the whole of the weld nut, and dried to form a film on the weld nut. The weld nut is fixed to a part to be fastened by means of electric resistance weld, but the spatter which adhered to the part is easily removed when fastening a bolt, and the fastening of the bolt could be smoothly carried out at a high axial force without a problem.

As described above, in the coating agent for preventing fixing of a weld spatter of the present invention, by using graphite having electrical conductivity as the coating material, even when not only the thread face but also the whole of a part is coated with the coating agent, the electrical conductivity of the part can be secured, and the coating of the coating agent can be conducted by a simple operation such as dipping, thus making it possible to reduce the production cost. In addition, by additionally adding boron nitride to graphite as the coating material, the resistance to oxidation of the coating material can be improved. Further, since the lubricating effect of graphite and boron nitride can be utilized, the coefficient of friction becomes stable and the fastening of a bolt can be conducted at a high axial force when fastening at a predetermined torque. Further, when an alcohol such as methanol, a ketone such as acetone, or an aromatic hydrocarbon such as benzene, is used as a solvent for dispersing therein the coating material, the resulting graphite liquid can be of a quick-drying type. Therefore, the graphite liquid can be dried in a short time after application of the graphite liquid, so that coating of the coating agent for preventing fixing of a weld spatter can be conducted at high productivity. Further, when, as a solvent for dispersing therein the coating material, a polyimide resin or polybenzoimidazole resin having a heat resistance or a halogenated epoxy-modified phenolic resin is used in the form of an aqueous solution or an aqueous dispersion, the water-soluble or aqueous dispersion solvent and the coating agent together form a suspension and therefore a graphite liquid having excellent heat resistance and high adhesion strength can be obtained. By using the thus obtained graphite liquid to form a film comprised mainly of graphite on a part, even when a weld spatter adheres to the part, the spatter is not strongly fixed to the part but can be easily removed therefrom. Therefore, no problem occurs when fastening a bolt and the appearance of the part are not spoiled. Accordingly, the present invention has a big industrial value as a coating agent which can prevent fixing of a weld spatterwith low cost, as a part coated with the coating agent and a method for preventing fixing of weld spatters.

1. A coating agent for preventing a fixing of a weld spatter, which comprises a coating material and a solvent for dispersing therein the coating material, wherein the coating material is graphite.

2. The coating agent according to claim 1, wherein the graphite is used in an amount of 1 to 50% by weight based on the total amount of the graphite and organic solvent.

3. The coating agent according to claim 1, wherein the coating agent further comprises a binder.

4. The coating agent according to claim 1, wherein the solvent is a mixture of water and a hydrophilic organic solvent.

5. A part coated with the coating agent according to claim 1, on at least a portion of the part to which a weld spatter spatters, to prevent the weld spatter from being fixed thereonto.

6. The part according to claim 5, which is a weld screw including a weld nut and a welding bolt.

7. A method for preventing fixing of weld spatters, which comprises coating the coating agent according to claim 1 onto at least a portion of a part of a screw for welding to which a weld spatter spatters or fixes, and drying the same.

8. The method for preventing fixing according to claim 7, wherein the coating is carried out by a spraying method or a dipping method.
